(19) United States
(12) Patent Application Publication
(10) Pub. No.: US 2006/0164219 A1
(43) Pub. Date: Jul. 27, 2006

(54) Method and device for warning the driver of a motor vehicle

(76) Inventor: Peter Knoll, Ettlingen (DE)

Correspondence Address: KENYON & KENYON LLP, ONE BROADWAY, NEW YORK, NY, 10004, US

(21) Appl. No.: 10/535,130

(22) PCT Filed: Sep. 26, 2003
(86) PCT No.: PCT/DE03/03214

§ 371 Date: Nov. 14, 2005

(30) Foreign Application Priority Data
Nov. 16, 2002 (DE) 102535094

(51) Int. Cl. B60Q 1/00

(52) U.S. Cl. 340/435

(57) ABSTRACT

A method and a device for warning the driver of a motor vehicle. An optical warning in the direction of at least one object of the vicinity of the vehicle is generated in the field of vision of the driver by a signaling device, the optical warning occurring at least prior to the object becoming visible to the driver. The optical warning is at least one patch of light and/or at least one warning symbol, where at least the display duration may be changed.

### FIELD OF THE INVENTION

The present invention relates to a method and a device for warning the driver of a motor vehicle.

### BACKGROUND INFORMATION

Obstacles that suddenly appear in the vicinity of the vehicle often lead to driving situations critical to the driver of a motor vehicle. Such driving situations occur, for example, when visibility is poor. In addition to the illumination conditions, the weather conditions determine the vision of the driver. Particularly difficult conditions are present, when poor illumination conditions and poor weather conditions are present, for example, when rain reduces the visibility at night. If obstacles, which are not visible to the driver or can only be seen by the driver at a late time, appear unexpectedly under such poor visibility conditions, this is often the cause of traffic accidents.

German Patent No. 40 32 927 describes a device for improving the visibility conditions in a vehicle having an infrared-sensitive camera and an indicating device taking the form of a head-up display. It is suggested that, as driver information, the image of the camera visually overlie the outer landscape in the form of a virtual image. A clear warning of the driver does not take place.

### SUMMARY OF THE INVENTION

The method and the device of the present invention for warning a driver of a motor vehicle allows the driver to be warned of objects in the vicinity of the motor vehicle, before the object is visible to the driver. This advantageously results in a temporal shift and, consequently, an earlier warning of the object in the vicinity of the motor vehicle. The generation of at least one optical warning in the direction of the at least one object in the field of view of the driver causes the driver to turn his eyes. In this context, it is particularly advantageous that the driver turns his eyes by reflex, without having to do it willfully. Since, in general, reflex reactions are considerably more rapid than deliberately controlled sequences, the eyes of the driver are turned in the direction of the object in a rapid and predictable manner. The generation of the optical warning in the direction of the object allows the eye-turning to be controlled in an advantageous manner, so that the attention of the driver is steered in the direction where the object in the vicinity of the motor vehicle is actually located. In summary, the subsequently described method and the device contribute towards reducing the number of accidents in a particularly advantageous manner while simultaneously reducing the workload of the driver. All in all, this yields the outstanding advantage of increasing the traffic safety.

A patch of light is advantageous as an optical warning, since patches of light are simple to generate. The use of at least one patch of light advantageously results in a favorable but efficient method and device. The generation of a warning signal in the form of an optical warning has the advantage over the related art that additional information may be generated in the at least one optical warning in a particularly simple manner. Using at least one warning symbol, it is possible to show the driver information about the type of object, for example, that the object is a passenger car and/or a truck and/or a motorcycle and/or a cyclist and/or a pedestrian. The use of a warning symbol instead of characters allows the information to be internationally understood. At least one patch of light and/or at least one warning symbol as at least one optical warning advantageously results in reasonable manufacturing costs of the subsequently described method and device, since no country-specific adaptations to different languages are necessary.

The attention of the driver is attracted to different degrees by changing the display duration and/or the repetition frequency and/or the size and/or the color and/or the intensity of the at least one optical warning. In particular, it is advantageously possible to cause the driver to turn his eyes at different speeds as a function of the object and/or the dangerousness of the object to the driver of the motor vehicle. For example, in dangerous situations, a large red patch of light having a high luminosity allows the eyes of the driver to be rapidly turned and, therefore, the attention of the driver to be rapidly steered in the direction of the object in the vicinity of the motor vehicle. A dangerous situation is then present, for example, when the danger of an accident originates from an object in the vicinity of the motor vehicle.

It is advantageous for the at least one optical warning to occur immediately prior to the at least one object becoming visible to the driver, since the driver may then immediately detect the object himself after turning his eyes in the direction of the object. By this means, the driver is made aware of the object but simultaneously has the option of analyzing and evaluating the actual driving situation in connection with the object. This advantageously allows the driver to recognize dangerous driving situations rapidly and reliably. He thereby gains valuable time to initiate appropriate measures for averting danger, such as breaking or steering maneuvers.

The at least one optical warning as a function of the driving situation advantageously leads to a reduction in the amount of information to be processed by the driver. By this means, it is possible for an optical warning of at least one object in the vicinity of the vehicle to only occur when, for example, a dangerous driving situation is present.

The use of at least one image-sensor system for generating optical information advantageously allows objects in the vicinity of the motor vehicle to be detected, which are not directly visible to the driver himself. For example, pedestrians who stop directly in front of a truck cannot be directly seen by the driver of the truck. The high, recessed sitting position of the truck driver sharply limits the view of the driver in this surrounding region. The use of at least one image-sensor system for monitoring these surrounding regions of the motor vehicle allows the driver to be informed of the existence of an object in this region by at least one optical warning. It is particularly advantageous to use at least one infrared-sensitive image-sensor system, since at night or in the event of rain and/or snowfall, infrared-sensitive image-sensor systems have a larger range of detection than the driver of a motor vehicle. For example, the range of vision of a motor-vehicle driver at night is approximately 40 meters with dimmed headlights, while in the case of good visibility, infrared-sensitive image-sensor systems have an object-detection range between 70 meters and 140 meters.

### BRIEF DESCRIPTION OF THE DRAWINGS

FIG. 1 shows a general diagram of the preferred exemplary embodiment for warning the driver of a motor vehicle

FIG. 2 shows a block diagram of the device for warning the driver of a motor vehicle.

FIG. 3 shows a flowchart.

### DETAILED DESCRIPTION

A method and a device for warning the driver of a motor vehicle is described below. An optical warning in the direction of at least one object of the vicinity of the vehicle is generated in the field of vision of the driver by a signaling device, the optical warning occurring at least prior to the object becoming visible to the driver. The optical warning is at least one patch of light and/or at least one warning symbol, where at least the display duration may be changed.

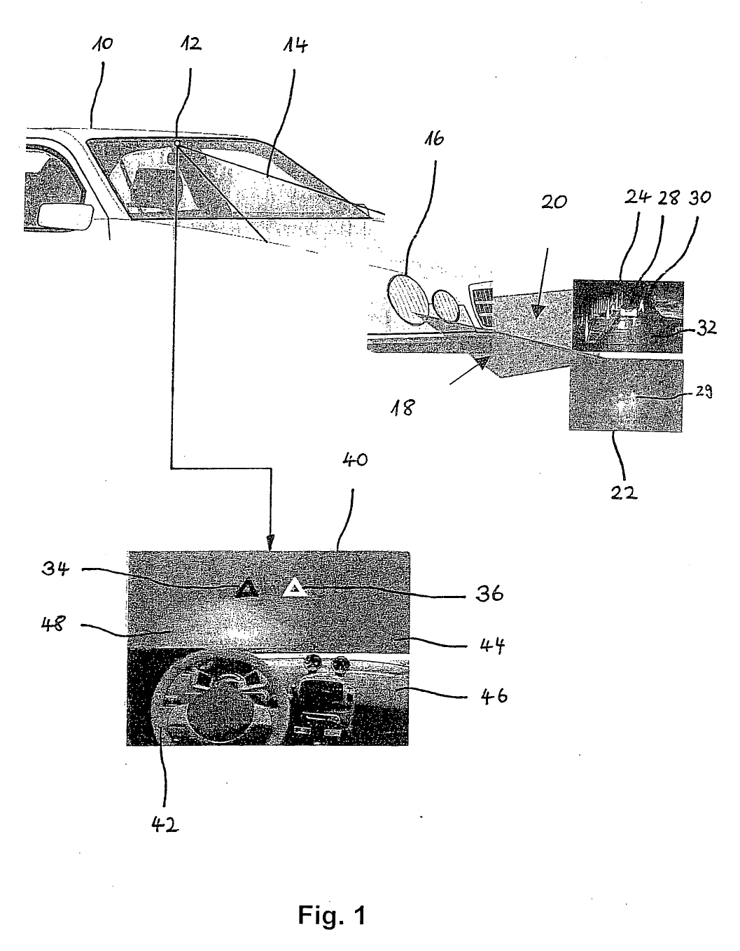

FIG. 1 shows a general diagram of the preferred exemplary embodiment for warning the driver in a motor vehicle 10, including an infrared-sensitive image-sensor system 12, a headlight 16, and the actual view of driver 40 of motor vehicle 10. In the interior of motor vehicle 10, image-sensor system 12 is mounted behind the windshield in the region of the interior rearview mirror. In this context, image-sensor system 12 is oriented so that detection range 14 of image-sensor system 12 extends to the surrounding area of motor vehicle 10 in the direction of travel. Image-sensor system 12 is an infrared-sensitive videocamera having a CMOS image sensor and/or a CCD image sensor. The image sensor of image-sensor system 12 detects at least near infrared radiation in the wavelength range of 780 nm to 1000 nm. Motor vehicle 10 is steered by a driver, motor vehicle 10 being situated on a road and moving in the direction of travel. In the situation shown in FIG. 1, the weather conditions and the illumination conditions are poor, -since darkness impairs the view of the driver. Two headlights 16, which are situated near the bumper on the right side and the left side of the front region of motor vehicle 10, illuminate the surroundings of motor vehicle 10 in the direction of travel. In FIG. 1, only one headlight 16 is drawn into a simplified representation. In addition to low beam 18 in the visible spectral range, headlights 16 generate high beam 20 in the infrared region of the spectrum. The range of low beam 18 is approximately 40 m. Headlights 16 have a high-beam function in the visible spectral range, with the aid of which the driver can see up to 200 m as a function of the weather conditions. In this exemplary embodiment, the high-beam function in the visible spectral range is not activated. Included in the emitted spectrum of the halogen lamps of headlights 16 is a high infrared component, which is emitted by these modified headlights 16, invisible to a human, using a high-beam characteristic. Perception 22 of the driver is sharply limited by the darkness. However, a better perception 24 of infrared-sensitive image-sensor system 12 is achieved by high-beam 20 by modifying front headlights 16 to emit at least near infrared radiation having wavelengths between 780 and 1000 nm. An approaching motor vehicle 28, a pedestrian 30, and roadway 32 can be seen in perception 24 of infrared-sensitive image-sensor system 12. However, only headlights 29 of oncoming motor vehicle 28 can be identified in perception 22 of the driver. Pedestrian 30 crossing behind approaching vehicle 28 may easily be detected in perception 24 of image-sensor system 12, while it is not visible in perception 22 of the driver. FIG. 1 also shows actual view of the driver 40, including steering wheel 42, windshield 44 and instrument panel 46. In this preferred exemplary embodiment, perception 24 of infrared-sensitive image-sensor system 12 is supplied to a processing unit, which only generates a warning when a dangerous condition is detected. With the aid of suitable image-processing algorithms, objects 28, 30 are detected in the detection field, i.e. near the course of the roadway, and objects 28, 30 are assigned to the course of the roadway. In this context, roadway 32 includes, in general, the lane of the vehicle in question and the lane of the oncoming traffic. In the case of expressways, roadway 32 is at least formed by separate lanes. Roadway 32 is defined by roadway markings, such as delineators and/or lane markings. In this context, the course of the roadway includes roadway 32 itself and adjoining regions of roadway 32, such as shoulders and/or sidewalks and/or bike paths and/or junctions of roads. In this preferred exemplary embodiment, an approaching motor vehicle 28 and a pedestrian 30 are detected as objects 28, 30. The processing unit detects the dangerousness of the situation. Using a projection device, in this exemplary embodiment a simple head-up display, a small warning symbol 34, 36 in the form of a marking 34 of approaching motor vehicle 28 and a marking 36 of pedestrian 30 is produced on windshield 44 in the line of sight of the driver, at the consequently determined position of approaching motor vehicle 28 and pedestrian 30. This causes the driver to move his eyes in the direction, in which objects 28, 30 actually appear later in the field of view as obstacles to the driver. In a first variant of the preferred exemplary embodiment, the optical warning is generated independently of the position of the driver. This is possible, since in the case of object distances greater than 40 meters, the observation cone for the roadway section lying ahead is relatively small. In a further variant, the head of the driver is detected by an image-sensor system (camera) mounted in the vehicle interior. The position of the head and/or the position of the eyes of the driver is ascertained from the picture of the head. From this, the line of sight of the driver to points, which are, for example, 100 m in front of the motor vehicle in its own lane, is calculated as a line of sight. The optical warning to be generated is made to overlap the line of sight calculated in this manner, in that a projection unit (head-up display) that can be turned in the x direction and y direction is appropriately turned. The deflection is preferably accomplished by micromechanical mirrors.

In this exemplary embodiment, a colored marking in the form of a red and/or yellow triangle is used as a warning symbol 34, 36. According to FIG. 1, the driver's actual view 40 of the surroundings of motor vehicle 10 includes light of the headlights 48 of approaching motor vehicle 28, a yellow marking 34 of approaching motor vehicle 28, and a red marking 36 of pedestrian 30. Markings 34, 36 direct the attention of the driver of motor vehicle 10 to these objects 28, 30. The image-processing algorithms are designed so that objects 28, 30 are only marked 34, 36, when objects 28, 30 are near the course of the roadway of motor vehicle 10, and/or when a dangerous condition exists. In this preferred embodiment, a dangerous condition is detected because pedestrian 30 is crossing roadway 32 in back of approaching motor vehicle 28, and there is the danger of a collision between vehicle in question 10 and pedestrian 30. A dangerous condition is then present, when an object 28, 30 is situated in the lane of the vehicle. Since, in the preferred exemplary embodiment, pedestrian 30 is in the lane of the vehicle, a marking 36 in the form of a red triangle is generated in the line of sight of the driver. A potentially dangerous situation is then present, when an object 28, 30 is in the vicinity of the vehicle's lane, e.g. a deer at the edge of the roadway and/or a pedestrian in the adjacent lane. Since approaching motor vehicle 28 is in the vicinity of the lane of the vehicle in question, a marking 34 in the form of a yellow triangle is generated in the line of sight of the driver.

Image sensors having a high resolution are used in the preferred embodiment of FIG. 1. Usable semiconductor image-sensor chips have resolutions, which are sufficient for providing a satisfactory graphic display and allow objects to be detected at distances up to 70 meters. The detection of objects more than 70 meters away from the image sensor requires higher-resolution image sensors (imagers) having standard resolutions of 1024×768 pixels or 1280×1024 pixels. A standard resolution of 1024×768 pixels allows objects up to approximately 110 meters away to be detected, while a standard resolution of 1280×1024 pixels allows objects up to approximately 140 meters away to be detected. In the preferred embodiment according to FIG. 1, the coating of the camera lens system is adapted to the utilized spectral region. In this context, the coating is designed so as to not significantly deteriorate the optical characteristics in the visible region of the spectrum. This allows the image-sensor system to also be used for other functions during the day, i.e. in the visible spectral range. In addition, the aperture of the lens system is adjusted to the prevailing dark sensitivity.

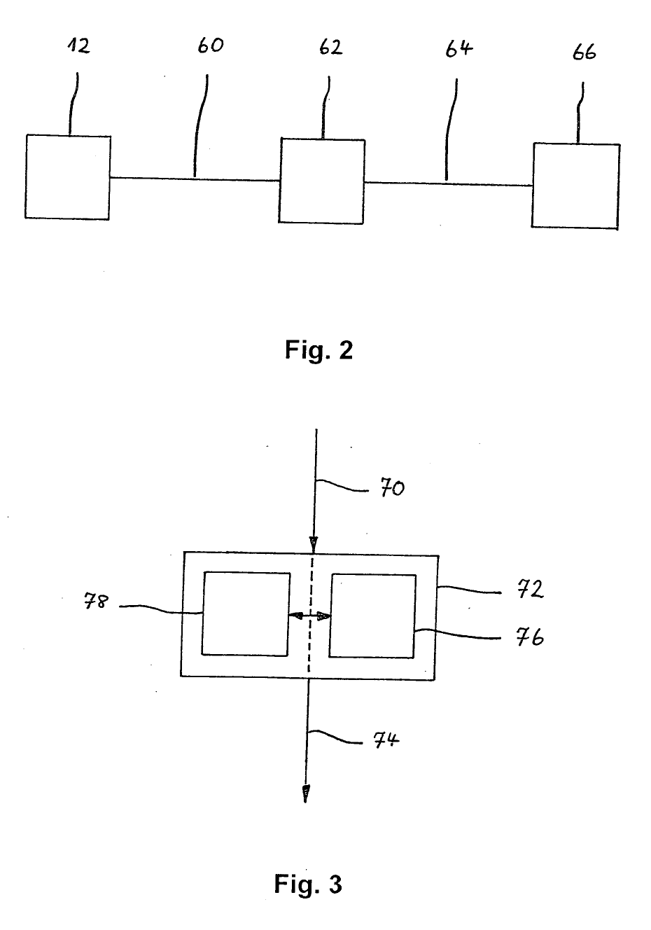

FIG. 2 shows a block diagram of the device for improving the visibility in a motor vehicle of the preferred exemplary embodiment according to FIG. 1, including an infrared-sensitive image-sensor system 12, a processing unit 62, and at least one signaling means 66. Infrared-sensitive image-sensor system 12 acquires optical signals of the surroundings of the motor vehicle in the form of image data. The optical signals are electrically and/or optically transmitted from infrared-sensitive image-sensor system 12 to processing unit 62 via signal line 60. Wireless transmission is alternatively or additionally possible. Processing unit 62 is made up of module 72, which is represented in FIG. 3 and is designed in this exemplary embodiment as a program of at least one microprocessor. In the preferred exemplary embodiment, processing unit 62 is physically separated from other components 12, 66. As an alternative, it is possible for processing unit 62 to form a unit together with image-sensor system 62, or for processing unit 62 to be accommodated in signaling means 66. Processing unit 62 calculates signals for warning the driver from the optical signals of infrared-sensitive image-sensor system 12. The processed signals for warning the driver are electrically and/or optically transmitted via a signal line 64 to at least one signaling means 66. Wireless transmission is alternatively or additionally possible. Signaling means 66 generate the actual optical warning from signals for warning the driver. In the preferred exemplary embodiment, a projection device is used as signaling means 66. The projection device is a simple head-up display, which generates an optical warning on the windshield.

FIG. 3 shows a flowchart of the method for improving the visibility in a motor vehicle according to the preferred exemplary embodiment in FIG. 1, and of the device according to FIG. 2, which is made up of processing module 72. Optical signals 70 are supplied to processing module 72, which processes signals for warning the driver 74 as output signals. The processing module is made up of two modules operating in parallel, namely module for detecting the course of the roadway 76 and module for object detection 78. The algorithms for lane and/or roadway detection of module for roadway-coarse detection 76 and the algorithms for object detection of module for object detection 78 are combined to form an overall algorithm. These two modules 76, 78 exchange information and partial results during the processing. In module for detecting the course of the roadway 76, objects that define the roadway or the lane are ascertained from optical signals 70. Examples of these objects include delineators and/or lane markings. The course of the roadway is calculated from the knowledge of the position of these objects. In module for object detection 78, objects 78 are also determined from the optical signals. The position of the detected objects is then calculated. This overall algorithm allows objects to be assigned to the course of the roadway, in particular to the lane and/or the road.

The described method and the device are not limited to a single signaling means. On the contrary, additional signaling means are used in one variant, in order to generate at least one optical warning. As an alternative to, or in addition to the projection device, at least one head-up display is used as a signaling means. A head-up display is a signaling means that generates a virtual image, which is reflected into the windshield of the motor vehicle in such a manner, that to the driver, the image appears to be several meters in front of the vehicle. In one variant, at least one head-up display is used for displaying at least one warning symbol.

In one variant of the method and the device, the at least one optical warning is additionally generated when the at least one object becomes visible to the driver. In this context, the at least one optical warning is carried out prior to the at least one object becoming visible to the driver, and the optical warning is continued upon the at least one object becoming visible.

In a further variant of the method and the device, at least one light patch is used as an optical warning. In this context, a patch of light is defined so as to be lacking in inherently contained information. The object of the light patch is simply to cause the driver to turn his eyes in the direction of an object. The shape of the at least one patch of light is circular and/or elliptical and/or star-shaped and/or triangular and/or rectangular and/or polygonal and/or blob-shaped. Alternatively, or in addition, the shape of the light patch is formed by a mosaic of at least one spot of light. In this instance, the light spot is generated by a light pulse.

In one variant of the described method and device, customary international and/or internationally understandable symbols are used as warning symbols. Characters, such as exclamation marks, and/or symbols similar to traffic signs and/or danger symbols are used as warning symbols.

In a further variant of the described method and the device, the display duration and/or the repetition frequency and/or the size and/or the color and/or the intensity of the at least one optical warning is alternatively or additionally changed. This causes the driver to turn his eyes at different speeds as a function of the object and/or the dangerousness of the object to the driver of the motor vehicle.

In a further variant, the at least one optical warning is generated immediately prior to the at least one object becoming visible to the driver. This allows the driver to detect the object immediately after turning his eyes, since the object becomes visible to the driver after the turning of the eyes. In this manner, the driver has the option of assessing the dangerousness of the object himself.

The described method and the device are not limited to a single image-sensor system. Rather, in one variant, additional image-sensor systems are used whose optical signals are supplied to the at least one processing unit. In this context, all of the utilized image-sensor systems are provided with color image sensors and/or black-and-white image sensors. The spectral sensitivity of the image-sensor systems is in the visible spectral range and/or in the infrared spectral range. Utilized in a further variant is at least one image-sensor system, which is made up of at least two image sensors, which essentially record the same scene. At least one stereo camera is used in a further variant.

In a further variant of the described device and the method, more than one processing unit is used. This allows the algorithms to be distributed among a plurality of processing units. At the same time, there is redundancy in the required computing power, so that in the event of a failure of a processing unit, the device and the method for improving the visibility continue to remain functional, since the remaining processing units compensate for the failure.

In a further variant of the described method and the device, the use of at least one additional sensor allows for improved warning of the driver of a motor vehicle. At least one radar sensor and/or at least one ultrasonic sensor and/or at least one LIDAR distance sensor is used as the at least one additional sensor. The use of at least one further sensor allows the position of at least one object and/or the course of the roadway to be redundantly determined.

1.-10. (canceled)

11. A method for warning a driver of a motor vehicle, comprising:
generating, in a direction of at least one object in a field of view of the driver, at least one optical warning by at least one signaling arrangement; the at least one object being situated in a vicinity of the motor vehicle, wherein the at least one optical warning is generated at least prior to the at least one object becoming visible to the driver.

12. The method as recited in claim 11, wherein the at least one optical warning includes at least one of at least one patch of light and at least one warning symbol.

13. The method as recited in claim 11, wherein at least one of a display duration, a repetition frequency, a size, a color, and an intensity of the at least one optical warning is changeable.

14. The method as recited in claim 11, wherein the at least one optical warning is generated immediately prior to the at least one object becoming visible to the driver.

15. The method as recited in claim 11, wherein the at least one optical warning is generated as a function of a dangerousness of a driving situation.

16. The method as recited in claim 11, wherein the at least one optical warning is at least generated as a function of an optical signal of surroundings of the motor vehicle, the optical signals being generated by at least one image-sensor system including an infrared-sensitive image-sensor system.

17. The method as recited in claim 11, wherein at least one of at least one projection device and at least one heads-up display serving as the at least one signaling arrangement generates the at least one optical warning.

18. A device for warning a driver of a motor vehicle, comprising:
at least one signaling arrangement for generating at least one optical warning, the at least one signaling means including an arrangement for generating the at least one optical warning in a direction of at least one object in a field of view of the driver, and the at least one object being situated in a vicinity of the motor vehicle, wherein the at least one signaling arrangement includes an arrangement for generating the at least one optical warning in the direction of the at least one object in the vicinity of the motor vehicle at least prior to the at least one object becoming visible to the driver.

19. The device as recited in claim 18, wherein the at least one signaling arrangement includes at least one of:
an arrangement for generating at least one of at least one patch of light and at least one warning symbol as the at least one optical warning;
an arrangement for changing at least one of a display duration, a size, a color, and an intensity of the at least one optical warning;
an arrangement for generating the at least one optical warning as a function of a dangerousness of a driving situation.

20. The device as recited in claim 18, further comprising:
at least one infrared-sensitive image-sensor system for generating an optical signal of surroundings of the motor vehicle, wherein the at least one signaling arrangement includes at least one of a projection device and at least one head-up display.
